(19) United States
(12) Patent Application Publication
(10) Pub. No.: US 2025/0178442 A1
(43) Pub. Date: Jun. 5, 2025

(54) BOOM AND TRAILING ARM CONTROL SYSTEM FOR DYNAMIC ENERGY TRANSFER

(71) Applicant: Caterpillar Inc., Peoria, IL (US)

(72) Inventor: Igor STRASHNY, Tucson, AZ (US)

(73) Assignee: Caterpillar Inc., Peoria, IL (US)

(21) Appl. No.: 18/524,234

(22) Filed: Nov. 30, 2023

(51) Int. Cl. B60L 5/16

(52) U.S. Cl. CPC B60L 5/16

(57) ABSTRACT

A boom and trailing arm control system includes an electronic control module, a plurality of sensors, and a rail connector assembly with a boom, an arm assembly, and a contactor assembly, the rail connector assembly configured to connect with a plurality of conductor rails. The control system also includes an input receiver for the electronic control module configured to receive an input to extend the rail connector assembly from a frame of a mobile machine. The electronic control module is configured to generate commands to extend the boom and arm assembly.

### TECHNICAL FIELD

The present disclosure relates generally to an energy transfer system for a mobile machine, and more specifically, to a control system for a connector assembly including a boom and a trailing arm.

### BACKGROUND

Mobile industrial machines, such as earth-moving machines, can be of substantial weight and can bear immense loads, thus requiring a large amount of power. Many industrial machines are driven by internal combustion engines. However, internal combustion engines have drawbacks such as fuel costs, fuel transport difficulties, and detrimental engine emissions. Accordingly, there has been a movement toward powering large mobile industrial machines with hybrid or all-electric power systems.

While hybrid and all-electric power systems for industrial machines are beneficial for alleviating fuel costs and emission concerns, these systems present challenges. For example, the use of hybrid or all-electric systems in an industrial capacity requires a significant investment in infrastructure, particularly due to the location of industrial worksites. While the use of overhead electricity-conducting lines is one solution for powering vehicles with predetermined routes or terrain (e.g., trains, subways, buses, etc.), overhead lines are not practical for all machines or worksites, such as freely-steerable industrial machines and worksites with uneven terrain. As a result, existing power systems, such as overhead lines, are not typically used in remote and uneven environments. Other problems include the ability to safely deliver electricity to a moving industrial vehicle. It is therefore beneficial for industrial machines to have control systems with the ability to quickly deploy or retract a connector assembly, either manually or automatically, with minimal, if any, assistance from the machine operator.

An electric deliver system for providing electric power to a traveling vehicle is described in International Patent App. Pub. No. WO 2020/186296 A1, published on Sep. 24, 2020 (“the '296 publication”). The system described in the '296 publication describes an electrical delivery system at a mine site for a moving vehicle where two conductors are anchored to relocatable roadside barriers. In order to charge the moving vehicle, the delivery system requires that a retractable arm must precisely engage with electrical connectors embedded within a horizontal channel of the roadside barriers. While the system described in the '296 publication may be helpful in some circumstances, the '296 publication does not describe a system to easily connect the electrical delivery system to the roadside electrical conductors.

Aspects of the present disclosure may solve one or more of the problems set forth above and/or other problems in the art. The scope of the current disclosure, however, is defined by the attached claims, and not by the ability to solve any specific problem.

### SUMMARY

In one aspect, a method of operating a rail connector assembly of a mobile machine may include receiving a request to extend the rail connector assembly, which includes a boom, a trailing arm assembly, and a contactor assembly, from a frame of the mobile machine and a request to extend the trailing arm assembly to electrically connect to a plurality of conductor rails. The method may also include generating movement commands to operate the rail connector assembly and determining a presence of electrical energy along the plurality of conductor rails using a continuity sensor connected to the contactor assembly.

In another aspect, a mobile machine power system may include an electronic control module with an input receiver, a plurality of sensors, and a rail connector assembly with a boom, an arm assembly, and a contactor assembly. The rail connector assembly may be configured to connect with a plurality of conductor rails and the input receiver may receive input to extend the rail connector assembly from a frame of a mobile machine. The electronic control module may be configured to generate commands to extend the boom and the arm assembly.

In yet another aspect, a method of disconnecting a connector assembly of a mobile machine from a plurality of conductor rails may include receiving, by a control system, an operator input to disengage the connector assembly from the plurality of conductor rails and generating connector assembly commands, through the control system. The connector assembly commands may include a first command for controlling a plurality of magnets and a plurality of extendable brushes of the contactor assembly, a second command for controlling the trailing arm assembly, and a third command for controlling a hydraulic system of the boom. The method may also include securing the connector assembly to a frame of the mobile machine.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of an electric mobile machine connected to a conducting rail power source via a deployed connector assembly, according to aspects of the present disclosure.

FIG. 2 is a side view of the electric mobile machine with the connector assembly in a retracted stowed state.

FIG. 3 is a side view of the electric mobile machine with a boom of the connector assembly extended and a trailing arm of the connector assembly in a retracted state.

FIG. 4 is a side view of the electric mobile machine with the connector assembly engaged with the conducting rail power source.

FIG. 5 is a cross-sectional view of conductor terminals housed within the contactor assembly.

FIG. 6 is block diagram of an exemplary machine control system.

FIG. 7 is a flowchart illustrating a method for controlling a rail connector assembly, according to aspects of the present disclosure.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

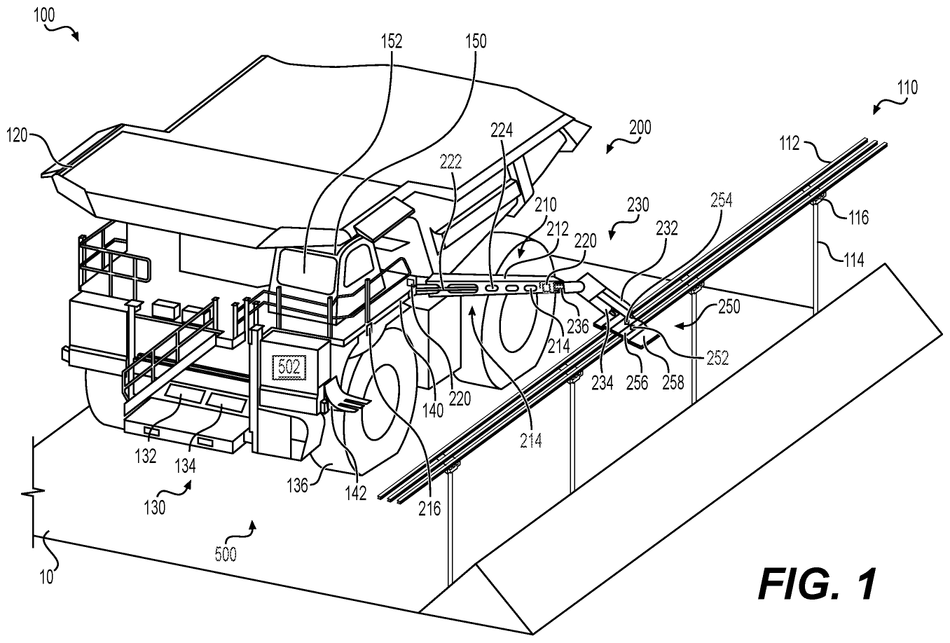

FIG. 1 depicts a mobile machine power system 100, according to aspects of the present disclosure. The mobile machine power system 100 includes an electrically-conducting rail system 110, a mobile machine 120 having a rail connector assembly 200, and a control system 500 including one or more sensors and an electronic control module (“ECM”) 502. The mobile machine 120 is free-steering and includes an electric drive system 130 having at least one electric motor 132 and at least one battery system 134.

The electric drive system 130 rotates a set of ground-engaging elements 136, such as tires or continuous tracks, for propelling and maneuvering the mobile machine 120. The mobile machine 120 also includes a frame 140 and an external shelf 142. The external shelf 142 serves as a storage platform for the trailing arm assembly 230 and the contactor assembly 250 and may be made of steel or any other appropriate magnetic material.

When in operation, the mobile machine 120 and its various systems are controlled via a machine operator located in the operator cabin 150, which may include a plurality of position indicators 152 presented within cabin 150. Examples of position indicators 152 include camera feeds, turn signal indicators, systemic representations or images of the position of the rail connector assembly 200 in relation to the electrically-conducting rail system 110, and others. Displays within the operator cabin 150 may display the position indicators 152 as well as system data or other visual feedback.

As shown in FIG. 1, the mobile machine 120 can be a mining truck, such as a haul truck utilized for transporting material in an opencast mine environment. The present disclosure is not thereby limited, however, and other types of machines are within the scope of the present disclosure, including articulated trucks, asphalt pavers, backhoe loaders, cold planers, compactors, dozers, draglines, drills, rope shovels, excavators, forest machines, hydraulic mining shovels, material handlers, motor graders, off-highway trucks, pipelayers, road reclaimers, skid steer and compact track loaders, telehandlers, track loaders, underground mining loaders and trucks, wheel loaders, or other similar vehicles. It may be appreciated by one having skill in the art that mobile machine 120 may utilize either hybrid or all-electric power systems, and the electrically-conducting rail system 110 may be applied to either system.

The exemplary mobile machine 120 is configured to travel (e.g., in a free-steering manner) along a work route or path, the electrically-conducting rail system 110 being positioned generally parallel to the route or path. The electrically-conducting rail system 110 of FIG. 1 includes a plurality of conductor rails 112 connected to a power-generating source (e.g., a power grid, generator, and/or energy storage devices), a plurality of support poles 114 secured to the ground 10, and a bracket assembly 116 attached to a top end of the each of the support poles 114 to retain the plurality of conducting rails 112 in a secured elevated position. While FIG. 1 shows an example where the plurality of conductor rails 112 contains three conductor rails, fewer or more rails 112 are possible. In this example, two of the conductor rails provide electrical power at different polarities while the third conductor rail provides a reference of 0 volts. The electrically conducting rail system may alternatively incorporate a three-phase power system, utilizing a three-rail power circuit in addition to a fourth conductor rail providing a reference of 0 volts.

The plurality of support poles 114 ground the electrically-conducting rail system 110, specifically contacting the conductor rail 112 that provides a reference of 0 volts. Individual support poles 114 may be rods, poles, posts, cylinders, stanchions, or similar structures and have a length for elevating and supporting the plurality of conductor rails 112. The plurality of support poles 114 may each have a length sufficient to support and stabilize the plurality of conducting rails 112 at a height of at least eight feet above the ground, for example. The support poles 114 are made of dielectric materials such as pultruded fiberglass-reinforced polymer (FRP), or other electrically insulating or dielectric materials.

To electrically connect the mobile machine 120 to the electrically-conducting rail system 110, the mobile machine 120 includes rail connector assembly 200, which includes a boom 210, a trailing arm assembly 230, and a contactor assembly 250. The boom 210 includes a housing 212 with a busbar assembly extending the length of the boom (not shown). The boom 210 also includes a hydraulic system 214 within the housing. The boom 210 is pivotally attached to a side surface of the frame 140 at a proximal end of the boom 210. The boom 210 pivots towards or away from the frame via the hydraulic system 214. The housing 212, which provides protection to the internal components of the boom 210, may be substantially parallelepiped and fabricated from a metal material (e.g., steel) or other suitable material. While the boom 210 is shown to be attached to a mining haul truck, the boom 210 may be incorporated in various types of mobile machines 120 by use of an interchangeable adapter (not shown), attached to the housing 212 that is specific to the type of machine being operated.

The housing 212 includes a plurality of maintenance openings 224 (FIG. 1) located along the length of the boom 210. The maintenance openings 224 allow for easy access to the internal systems of the boom 210 without the need to completely detach the boom 210 from the mobile machine 120. For example, the maintenance openings 224 allow for an operator or a mechanic to replace components of the hydraulic system 214 or the pneumatic system 236, and also ensure the proper connection of the busbar assembly within the boom 210.

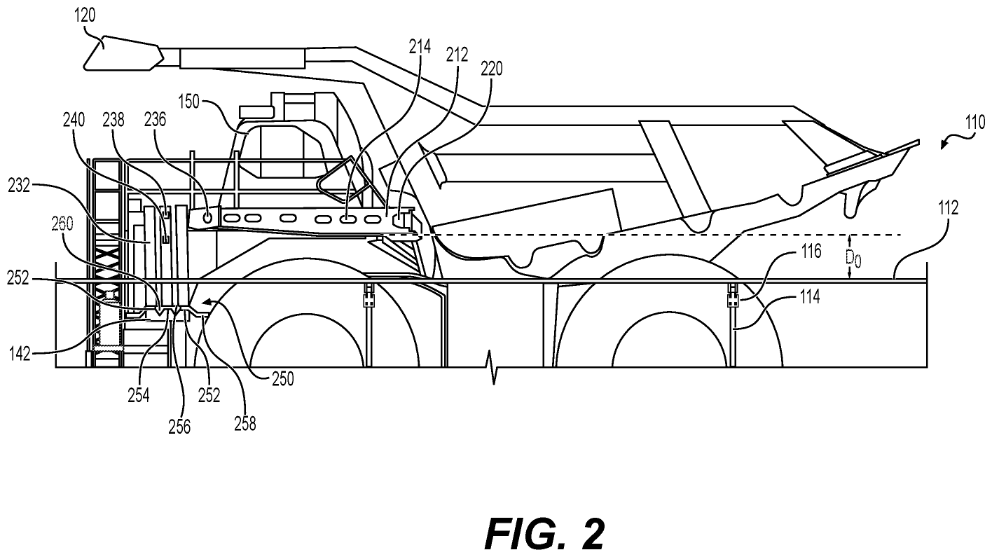

The boom 210 includes several different states, such as an extended state (shown in FIGS. 1, 3, and 4) in which the boom is extended away from the mobile machine, a retracted state (shown in FIG. 2) in which the boom is rotated inward to rest against the frame 140 of the mobile machine, and a locked state (also shown in FIG. 2) in which the boom is locked to the side of the frame in the retracted state. As shown in FIG. 1, when in an extended state, the boom 210 is pivoted outward from the mobile machine 120 in a horizontal direction so that the boom is normal to the mobile machine 120. As shown in FIGS. 1-4, the boom 210 is attached to the frame 140 of the mobile machine 120 at a height greater than the height of the conductor rails 112. The distance between the height of the boom and the height of the conductor rails 112 is represented by distance Do (FIG. 2).

When in a locked state, a locking pin on the boom 210 is actuated into a locked state and the boom 210 is secured in the retracted state (FIG. 2). When initiating an unlock sequence, the locking pin on the boom 210 is actuated to an open or free position, which allows for the boom, though still in the retracted state, to be manipulated or positioned by a user. This unlocked, yet retracted position may aid in servicing the connector assembly 200 and allow for the removal or integration of additional components.

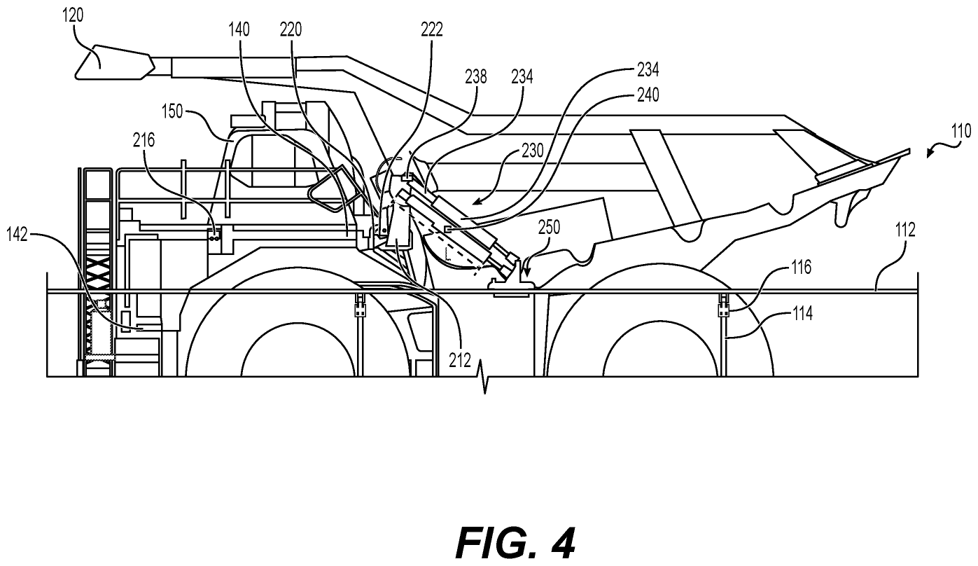

FIG. 1 also depicts the trailing arm assembly 230 attached to a distal end of the boom 210 by a connection (not shown) that allows for the movement of the plurality of trailing arms 232 (best shown in FIG. 4) with two degrees of freedom (e.g., movement in a horizontal direction and movement in a vertical direction) independent of the movement of the boom 210. The multiple degrees of freedom provide the connector assembly 200 with lateral and vertical freedom to adjust to the electrically-conducting rail system 110 during use of the mobile machine 120. More specifically, the trailing arm assembly 230 accommodates changes in relative position between plurality of conductor rails 112 and mobile machine 120 (e.g., increases or decreases to distance Do) during travel.

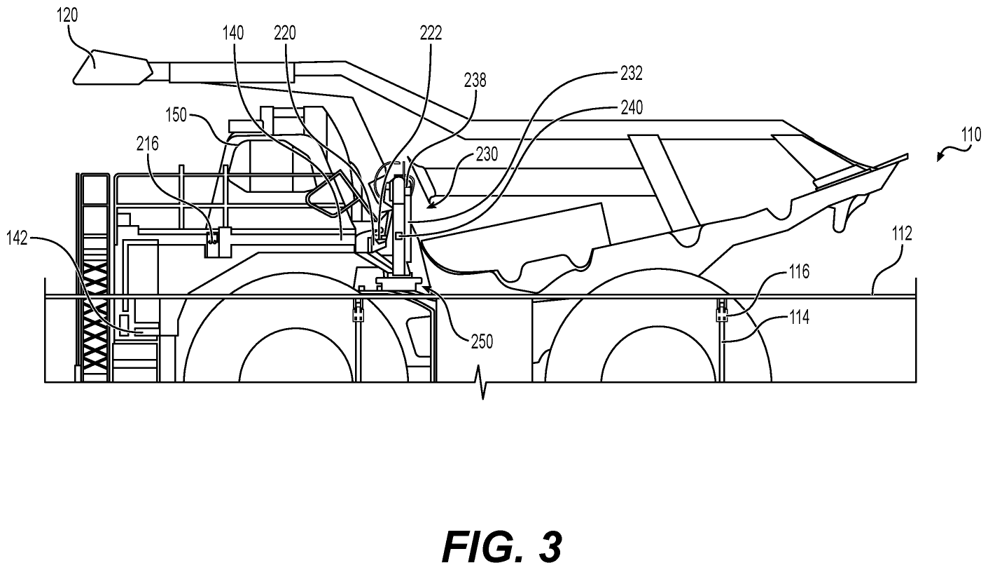

With reference to FIG. 4, each of the trailing arms 232 includes a plurality of telescoping links 234 with connection sockets (not shown), housed within the plurality of telescoping links, for the extension and retraction between the different states of the trailing arm assembly. In operation, the trailing arm assembly 230 is capable of multiple configurations or states, including a fully-extended state (shown in FIGS. 1 and 4), a stowed state (shown in FIG. 2) in which the trailing arm assembly 230 is slightly extended to place the contactor assembly 250 in contact with the shelf 142, and a retracted state (shown in FIG. 3) in which the trailing arm assembly is retracted to allow the contactor assembly 250 to be free of the shelf and the trailing arm assembly is positioned above the conductor rails 112. In the retracted state (shown in FIG. 3), the contactor assembly 250 is not attached or in contact with the conductor rails 112.

The contactor assembly 250 includes a base frame 256 in which a plurality of conducting terminals 262 are secured. In an exemplary configuration, nine conducting terminals 262 are arranged in a three-by-three matrix to provide redundancy and maintain electrical connection with the conductor rails 112; however, the conducting terminals 262 may be arranged in different quantities and in other configurations. In the exemplary rail configuration of three conductor rails 112 and utilizing the three-by-three conducting terminal matrix, the plurality of conducting terminals 262 are split into three equal groups of three conducting terminals arranged in a linear fashion. The three groups of linear conducting terminals 262 each correspond to one of the positive polarity conductor rail, the negative polarity conductor rail, and the conductor rail providing a reference of 0 volts.

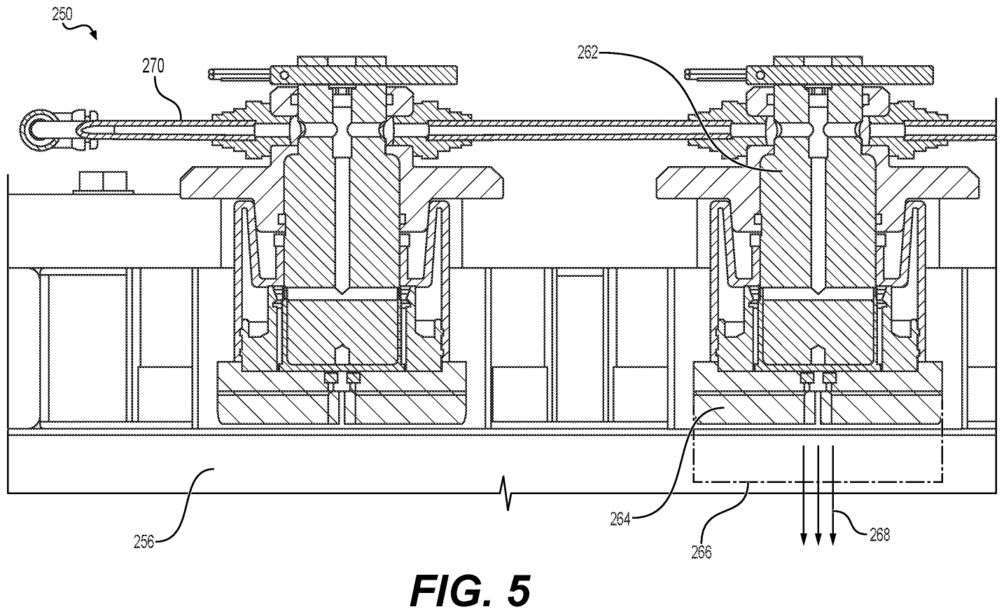

As shown in FIG. 5, each individual conducting terminal 262 is fluidly connected to the pneumatic system 236 of the trailing arm assembly 230 via a conduit 270, with each of the conducting terminals 262 further including a plurality of magnets (not shown) and an extendable brush 264. The contactor assembly 250 further includes several retaining features for maintaining the connection of contactor assembly 250 with the plurality of conductor rails 112. For example, the base frame 256 includes a pair of lower flanges 258 (FIG. 2) located on opposite lateral sides of the base frame 256, as well as a pair of bumpers 260 that separate the respective groups of conducting terminals 262 from each other. Individual groups of conducting terminals 262 align with the individual conductor rails 112, and the individual bumpers 260 align with gaps located between the conductor rails 112.

While the trailing arm assembly 230 provides multiple degrees of freedom and movement in horizontal and vertical directions, the contactor assembly 250 generally may be restricted to pivoting movement about the distal end of the trailing arm assembly 230. Providing restrictions to movement may help prevent a glancing or unstable connection with the conductor rails 112 and provides the power system 100 with a stable platform to connect to the electrically-conducting rail system 110.

The connector assembly 200 of the mobile machine 120 is configured to be electrically connected to the electrically-conducting rail system 110. For example, the contactor assembly 250 provides an electrical connection via the plurality of conducting terminals 262, allowing the electrical energy to be transmitted from the contactor assembly 250 to the trailing arm assembly 230. The electrical energy is then routed from the fully-extended trailing arm assembly 230, as shown in FIG. 1, to the busbar assembly within the boom 210, which is then transferred to the motor 132 and/or battery system 134.

As best shown in FIG. 1, the connector assembly 200 may be controlled by the control system 500, which may be controlled by an operator or may be automatically generated. In the illustrated configuration, the control system 500 includes the ECM 502 and one or more sensors that provide angular, linear, rotary, and proximity feedback or other information, as inputs to ECM 502. The sensors of control system 500 may include lock sensor 216 that generates a lock signal 514, angle sensor 220 that generates an angle signal 516, hydraulic sensors 222 that generate a hydraulic signal 518, trailing arm position sensors 238 that generate a position signal 520, pneumatic sensors 240 that generate a pneumatic signal 522, voltage sensors 252 that generate a voltage signal 524, and/or ground sensors 254 that generate a ground signal 526.

The lock sensor 216 (best shown in FIG. 1) is attached to the frame 140 of the mobile machine 120. The lock sensor 216 is configured to sense the proximity of the boom relative to the side of the mobile machine 120. The angle sensor 220 (best shown in FIG. 1) for the boom 210 is located at or near the attachment point between the frame 140 and the proximal end of the boom. The angle sensor 220 provides the ECM 502 with angular data corresponding to whether the boom 210 is fully extended (FIG. 1) or whether the boom is retracted against the mobile machine (FIG. 2). Additionally, the hydraulic sensors 222 on the boom 210 provide rotary data to the ECM 502 which may correspond to control of the hydraulic components housed within the boom, the actuation of hydraulic cylinders, and the rotational movement of the boom.

The trailing arm assembly 230 may include one or more position sensors 238 (FIGS. 2-4), with position sensor(s) 238 being housed within each trailing arm 232. The position sensor(s) 238 provide(s) vertical and horizontal location information of the trailing arms 232 to the ECM 502 and is used to indicate the alignment of the trailing arm assembly 230 with the electrically-conducting rail system 110, and specifically the conductor rails 112. The trailing arm assembly 230 also includes pneumatic sensors 240 (FIGS. 2-4) for regulating the extension and retraction of the trailing arms and for engaging or disengaging of the contactor assembly 250 with the conductor rails 112.

Contactor assembly 250 further includes a plurality of voltage sensors 252 and a plurality of ground sensors 254 (collectively referred to as “continuity sensors”). The continuity sensors are in electrical communication with the plurality of conducting terminals 262 of the contactor assembly 250 and provide the ECM 502 with voltage information or other related data. If desired, the data from the continuity sensors can be provided in a continuous (e.g., real-time) manner. For example, during operation in an exemplary configuration, individual groups of three conducting terminals 262 are arranged in a line. The continuity sensors 252, 254 for the individual groups of three conducting terminals 262 continuously test for the presence of a voltage or ground (e.g., the reference of 0 volts) on its respective conductor rail 112. More specifically, for each group of three conducting terminals 262, the first two conducting terminals 262 test for the presence of voltage or ground at a transition between the current section of an individual conductor rail 112 and a new section of another conductor rail 112, while the remaining conducting terminal confirms the presence of voltage or ground on the current section of rail. The data provided by the continuity sensors may correspond to commands from the ECM 502 relating to the engagement of the contactor assembly 250, the reaction of the pneumatic system 236 to disengage the brushes 264, and the transfer of electrical energy from the conductor rails 112 to the battery system 134 of the mobile machine 120.

ECM 502 may be made of a single physical module or may include multiple physical modules with each module relating to a specific task or function. ECM 502 may include a single microprocessor or multiple microprocessors configured to receive inputs and generate outputs in the form of commands to control the operation of components of the connector assembly 200. The ECM 502 may include programming to calculate the optimal operation of the conductor assembly 200, to generate outputs to be executed by the connector assembly 200 and/or other components of the machine 120, and to perform the functions described herein.

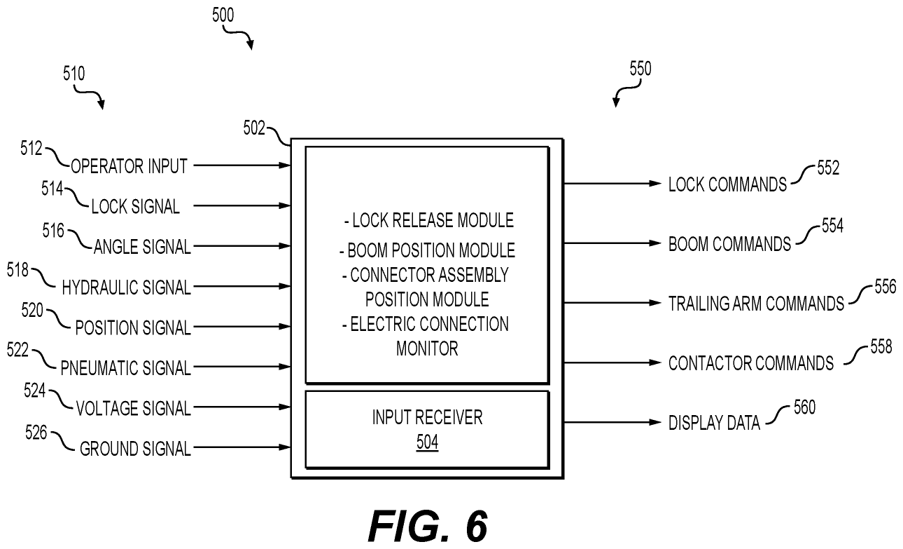

FIG. 6 is a block diagram illustrating an exemplary configuration of the control system 500, including the ECM 502, which may be programmed to perform the functions of a lock release module, a boom position module, a connector assembly position module, and an electric connection monitor, as described below. Inputs 510 are received by an input receiver 504 of the ECM 502 from the above described sensors. The inputs 510 may include operator inputs 512 from input devices (e.g., joysticks, pedals, control buttons, switches, etc.), preprogrammed sequences or routines for the mobile machine, boom sensor information (e.g., the lock signal 514, the angle signal 516, and the hydraulic signal 518), trailing arm data inputs (e.g., the position signal 520, the pneumatic signal 522), and continuity sensor information (e.g., voltage signal 524 and ground signal 526) obtained from the contactor assembly.

The outputs 550, as shown in FIG. 6, may also include a notification, such as an in-cabin indicators. Outputs 550 generated by the control system 500 may also include lock commands 552 for the locking pin, boom commands 554 for the hydraulic system 214, trailing arm assembly commands 556 for the pneumatic system 236 (thereby controlling the plurality of telescoping links 234 of the plurality of trailing arms 232), connector assembly commands 558 for the pneumatic system 236 (thereby controlling the plurality of extendable brushes 264), and data display commands 560, as described below.

### INDUSTRIAL APPLICABILITY

The disclosed aspects of the control system above can be used for deploying and controlling a rail connector assembly while charging a free-steering mobile machine with an electrically-conducting rail system on a worksite. For example, the drawings illustrate the connector assembly in various states of engagement with the electrically-conducting rail system and a block representation of the rail connector control system.

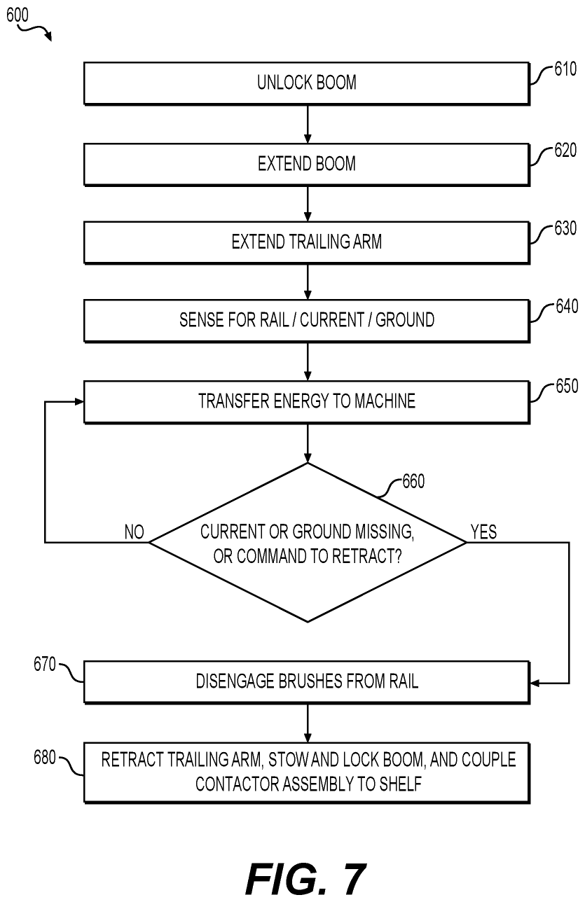

FIG. 7 is a flowchart illustrating an exemplary method 600 for operating a connector assembly 200 of a mobile machine power system 100 according to aspects of the present disclosure. Prior to the performance of method 600, the connector assembly 200 may be in the state shown in FIG. 2. While in this locked state, the trailing arm assembly 230 and the contactor assembly 250 are retained on the shelf 142 (FIG. 2) due to the magnetic force generated by the magnets (not shown) housed within the base frame 256 and the combined mass of the trailing arm assembly and the contactor assembly. The trailing arm assembly 230 and the contactor assembly are oriented in a vertical direction relative to the ground 10. Also, prior to unlocking the boom 210, the lock sensor 216 (FIG. 1) provides a signal 514 to the control system 500 indicating that the locking pin is in a locked state.

Step 610 may include unlocking the boom 210 from the frame 140 of the mobile machine 120. For example, the ECM 502 receives a request to extend the rail connector assembly 200 (e.g., including a request to extend the trailing arm assembly 230), determines that the boom 210 is locked, and in response initiates an unlock or open command 552 to an actuator for the locking pin, thereby moving the locking pin into an open or free position. The request to extend the rail connector assembly and the request to extend the trailing arm assembly may be a single request generated by an operator pushing a button in the operator cabin 150 or may be automatically generated based on a geographic location of the machine 120 as determined by a Global Navigation Satellite System (“GNSS”).

As a part of step 610 or in a subsequent step, a trailing arm command 556 may be generated with the ECM 502 to cause the plurality of telescoping links 234 to retract from the stowed state (FIG. 2) to the retracted state (FIG. 3). The ECM 502 initiates a contactor assembly command 558, signaling to the pneumatic system to provide fluid pressure to actuate the extendable brushes 264 in the contactor assembly. As shown in FIG. 5, the retraction of the trailing arms away from the shelf 142 and the extension 266 of the extendable brushes 264 in a direction 268 (in opposition to the shelf 142) results in a force greater than the combined gravitational and magnetic forces necessary to keep the contactor assembly 250 on the shelf, transitioning from the stowed state in which the contactor assembly 250 rests on the shelf 142 into the retracted state, in which the trailing arm assembly 230 is slightly retracted from the shelf 142 and the combination of the trailing arm assembly and the contactor assembly are capable of freely travelling in conjunction with the boom 210.

Step 620 of the method 600 may include extending the boom 210 from the retracted state by generating a boom command 554 to extend the boom from a retracted state to the fully-extended state as shown in FIG. 1. Step 620 may be performed in response to receiving operator input 512 by the inputs receiver 504 for extending the rail connector assembly 200. The ECM 502 provides a boom command 554 to the hydraulic system 214 in Step 620, signaling for the extension of the boom 210 outward from the side of the mobile machine 120. As the boom 210 is extended, the retracted trailing arm assembly 230 is rotated outward at a distal end of the boom and is oriented in a vertical direction relative to the ground 10, as shown in FIG. 3. When the boom 210 has been fully extended, the angle sensor 220 provides an angle signal 516 to the inputs receiver 504, indicating the boom 210 has reached its maximum outward position.

In Step 630, the control system 500 may extend the trailing arms 232 in response to a request (e.g., via operator input 512) for the extension of the trailing arm assembly 230. The ECM 502 then generates a trailing arm command 556 to the actuators for the pneumatic system (e.g., while monitoring actuation via signal 522 from pneumatic sensors 240). This may cause the pneumatic system 236 to supply pressurized fluid to the plurality of telescoping links 234 to fully extend the plurality of trailing arms 232. The trailing arms 232 fully extend in a direction generally towards the ground 10 from the distal end of the boom 210, with the connection sockets of links 234 each forming an electrical connection for conducting electrical energy along the length of the telescoping arms 232.

In the fully extended state, the trailing arm assembly 230 is extended to a length, L (FIG. 4) that is greater than distance Do. Therefore, upon meeting the electrically-conducting rail system 110, the trailing arm assembly 230 rotates rearward, in a direction opposite to direction of the movement of the mobile machine 120, such that the contactor assembly 250 trails behind the boom 210 (FIG. 4). The trailing arm assembly 230 can be extended either while the mobile machine 120 is in motion during operation or when the mobile machine at rest or stopped.

In Step 630, the contactor assembly 250 aligns with the plurality of conductor rails 112. In operation (FIG. 4), a force of gravity acts on the combined masses of the trailing arm assembly 230 and the contactor assembly 250 and a magnetic force generated by the plurality of magnets (not shown) housed within the base frame 256 encourage a connection between the contactor assembly 250 and the plurality of conductor rails 112.

In Step 640, the control system 500 determines whether the trailing arm assembly 230 is aligned with the plurality of conductor rails 112 by sensing the presence of an electrical current and ground in the plurality of conductor rails through the use of the continuity sensors in the contactor assembly 250, as well as the alignment of the rails through the use of the position sensors 238 housed with the plurality of trailing arms 232. To determine the alignment of the trailing arm assembly 230 relative to the rails, position sensors 238 and the continuity sensors provide feedback to the control system 500, which generates the appropriate movement commands as necessary. Position sensors 238 are secured near or within the plurality of trailing arms 232 and provide vertical and horizontal position data to the control system. Once the control system has received the position signal 520, the ECM 502 may generate display data 560 in the form of position indicators 152 for the operator in the cabin 150. The position indicators may include camera images, turn signal indicators for guiding the operator on the positioning of the trailing arm assembly 230, image representations of the connector arm assembly 200 in relation to the electrically-conducting rail system 110, or other suitable representations. Likewise, continuity sensors, specifically the voltage sensors 252 and the ground sensors 254, continuously test for the presence of voltage or ground along the conductor rails and transfer voltage and ground information to the control system.

In step 650, if the contactor assembly 250 is properly aligned with the rails and confirms the presence of an electrical current and ground, the electrical energy carried by the electrically-conducting rail system 110 is transferred from the plurality of conductor rails 112 to the contactor assembly 250, along the trailing arm assembly 230, through the busbar assembly within the boom 210 and to the battery system 134 of the mobile machine 120. The electrical transfer from the conductor rails 112 to the battery system 134 may continue for as long as necessary to either charge the battery system 134 fully or as long as the operator deems necessary.

Step 660 includes determining whether the current or ground connection is missing (e.g., disconnected) and determining whether the ECM 502 received a command to retract the rail connector assembly 200. The determination in Step 660 is “no” when current and ground are connected, as indicated by signals 524 and 526, and no retraction request is received via operator input 512.

However, the determination in Step 660 is “yes” if the connector assembly control system determines that the contactor assembly 250 is not properly aligned with the conductor rails 112 or that an electrical current or ground is not present on the conductor rails 112. Method 600 may then proceed to Step 670, in which the control system 500 generates a contactor assembly command 558 to disengage from the plurality of conductor rails 112. The contactor assembly command 558 signals to the pneumatic system 236 to generate fluid pressure in the plurality of extendable brushes 264, located in the contactor assembly 250, to create a disengaging force that is greater than the magnetic and gravitational forces acting on the contactor assembly. The extendable brushes 264 would extend in a downward direction 268 (FIG. 5) towards the conductor rails 112, with the brush extension 266 thereby disconnecting the electrical connection of the conducting terminals 262 with the rails.

Once the contactor assembly 250 has been disconnected from the conductor rails, Step 680 may be performed by generating a trailing arm command 556 to retract the trailing arm assembly 230 from the fully-extended state (FIG. 4) to the retracted state. Specifically, the trailing arm command 556 signals to the pneumatic system 236 to retract the plurality of trailing arms 232, resulting in the trailing arms 232 being oriented in a vertical direction relative to the ground at the distal end of the boom 210 and the disconnected contactor assembly 250 hanging from the trailing arm assembly above the conductor rails 112, as shown in FIG. 3.

As part of Step 680, the ECM 502 may subsequently or simultaneously generate a boom command 554, signaling to the hydraulic system 214 of the boom 210 to retract the boom from the fully-extended state (FIG. 3) to the retracted state (FIG. 2). The angle sensor 220 communicates with the inputs receiver 504, providing angle signal 516 when the boom has been fully retracted. Once retracted, the lock sensor 216 senses the proximity of the boom 210 and provides a proximity indicator to the control system. The ECM 502 generates a lock command 552 to the locking pin to actuate the locking pin, locking the boom 210 to the side of the mobile machine 120.

In addition to the retraction of the trailing arm assembly 230 and the locking of the boom, Step 680 can include coupling the contactor assembly 250 to the shelf 142. For example, prior to or upon locking the boom 210, the pneumatic sensors 240 in the trailing arm assembly 230 send a pneumatic signal 522 to the inputs receiver 504 to extend the telescoping links 234 of the trailing arm assembly 230. The ECM 502 calculates and generates a trailing arm command 556 that extends the plurality of trailing arms so that the contactor assembly 250 abuts the shelf 142. Once contact has been made, the combined mass of the trailing arm assembly 230 and the contactor assembly 250 and the magnetic force created by the magnets integrated into the base frame 256 effectively couple the contactor assembly 250 to the shelf 142 in the stowed state as shown in FIG. 2.

In accordance with the present disclosure, the control system for the rail connector assembly of the mobile machine provides a sequence of conditions and calculations in order to securely and safely connect the mobile machine to the electrically-conducting rail system for charging. Furthermore, the control system provides for the automated deployment and engagement of the connector assembly along any route on an industrial worksite without the need for an operator to manage the deployment. Finally, the control system provides additional safety by continuously testing for the presence of current and a ground and quickly disengaging from the conductor rails when there is a lack of current, a lack of a ground, or if the connector assembly is not properly aligned.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A method of operating a rail connector assembly of a mobile machine, the method including steps of:
receiving, with an electronic control module:
a request to extend the rail connector assembly from a frame of the mobile machine, the rail connector assembly including a boom, a trailing arm assembly, and a contactor assembly, and
a request to extend the trailing arm assembly to electrically connect to a plurality of conductor rails;
generating movement commands, with the electronic control module, to operate the rail connector assembly; and
determining, with the electronic control module, a presence of electrical energy along the plurality of conductor rails using a continuity sensor connected to the contactor assembly.

2. The method of claim 1, further including generating a boom extension command, the boom extension command causing a hydraulic system to extend the boom which is pivotally attached to a side of the mobile machine.

3. The method of claim 2, wherein the boom is attached at a proximal end of the boom to the mobile machine at a height that is greater than a height of the plurality of conductor rails.

4. The method of claim 3, further including generating a trailing arm extension command that causes a pneumatic system to extend the trailing arm assembly.

5. The method of claim 4, wherein the trailing arm assembly is rotatably attached at a distal end of the boom and has a vertical orientation relative to the ground, wherein, when the trailing arm assembly is fully-extended, a length of the trailing arm assembly that is greater than a first difference between the height of the proximal end of the boom and the height of the plurality of conductor rails.

6. The method of claim 1, further including rotating the trailing arm assembly in a rearward direction relative to a direction of travel of the mobile machine, such that the trailing arm assembly and the contactor assembly trail the boom.

7. The method of claim 1, further including receiving position data from a plurality of position sensors with the electronic control module to determine a position of the trailing arm assembly.

8. The method of claim 1, further including determining contact of the contactor assembly with the plurality of conductor rails based on detected voltage.

9. The method of claim 8, wherein the contactor assembly includes one or more voltage sensors and one or more ground sensors, and
the method further includes receiving data indicating the presence of an electrical voltage and a ground potential with the one or more voltage sensors and with the one or more ground sensors.

10. The method of claim 9, further including extending a plurality of extendable brushes of the contactor assembly based on the data received from the one or more voltage sensors or the one or more ground sensors.

11. A mobile machine power system, the system comprising:
an electronic control module, the electronic control module including an input receiver;
a plurality of sensors; and
a rail connector assembly, the rail connector assembly including a boom, an arm assembly, and a contactor assembly, wherein the rail connector assembly is configured to connect with a plurality of conductor rails,
wherein the input receiver is configured to receive an input to extend the rail connector assembly from a frame of a mobile machine and the electronic control module is configured to generate commands to extend the boom and the arm assembly.

12. The system of claim 11, wherein the plurality of sensors includes a boom sensor, an arm assembly sensor, and a contactor assembly sensor.

13. The system of claim 12, wherein the boom sensor includes one or more of a locking sensor, an angle sensor, or a plurality of hydraulic sensors,
the locking sensor being located on the frame of the mobile machine;
the angle sensor being located at an attachment point between the frame of the mobile machine and an end of the boom proximal to the mobile machine; and
the plurality of hydraulic sensors being attached to hydraulic components housed within the boom.

14. The system of claim 12, wherein the arm assembly sensor includes a position sensor and a pneumatic sensor.

15. The system of claim 12, wherein the contactor assembly sensor includes a voltage sensor and a ground sensor, and
wherein the voltage sensor and the ground sensor are configured to detect electrical contact of the contactor assembly with a plurality of conductor rails.

16. The system of claim 12, wherein the electronic control module is configured to generate output commands that include movement commands to extend the boom and to extend or retract the arm assembly, and commands to the contactor assembly.

17. A method of disconnecting a connector assembly of a mobile machine from a plurality of conductor rails, the method comprising steps of:
receiving, by a control system, an operator input to disengage the connector assembly from the plurality of conductor rails, the connector assembly including a boom, a trailing arm assembly, and a contactor assembly;
generating connector assembly commands, through the control system, including:
a first command for controlling the contactor assembly, the contactor assembly including a plurality of magnets and a plurality of extendable brushes,
a second command for controlling the trailing arm assembly, and
a third command for controlling the boom, the boom including a hydraulic system; and
securing the connector assembly to a frame of the mobile machine.

18. The method of claim 17, wherein the first command causes a pneumatic system to extend the plurality of extendable brushes and disengage from the plurality of conductor rails.

19. The method of claim 18, wherein the contactor assembly, with a mass, is connected to the plurality of conductor rails by a combination of a gravitational force acting on said mass and a magnetic force generated by the plurality of magnets, and
wherein an extension of the plurality of extendable brushes generates a pneumatic force greater than a combination of the gravitational force and magnetic force.

20. The method of claim 17, further including causing a pneumatic system to retract the trailing arm assembly from a fully-extended state to a retracted state; and
signaling to the hydraulic system to retract the boom from a fully-extended state extending outward from the frame of the mobile machine to a retracted state in which the boom is positioned against the frame of the mobile machine.
